(19) United States
(12) Patent Application Publication
(10) Pub. No.: US 2005/0010054 A1
(43) Pub. Date: Jan. 13, 2005

(54) Preparation of crystalline polymorphs of fosinopril sodium

(76) Inventors: Sandra Gallego Pato, Alcala De Henares (ES); Antonio Luis Palomo Coll, Barcelona (ES); Francisco Eugenio Palomo Nicolau, Alcala De Henares (ES)

Correspondence Address: STEINBERG & RASKIN, P.C., 1140 AVENUE OF THE AMERICAS, 15th FLOOR, NEW YORK, NY, 10036-5803, US

(21) Appl. No.: 10/496,748

(22) PCT Filed: Nov. 19, 2002
(86) PCT No.: PCT/IB02/04828

(30) Foreign Application Priority Data
Nov. 30, 2001 (ES) P200102739

(51) Int. Cl. C07F 9/547

(52) U.S. Cl. 548/413

(57) ABSTRACT

A new procedure is described for the selective preparation of crystalline polymorphs A and B of fosinopril, especially polymorph A. The procedure described allows to avoid the use of significant quantities of water, thus resulting in a lower risk of hydrolytic degradations of the active ingredient.

### FIELD OF THE TECHNIQUE

This invention relates to a new procedure for the selective preparation of the crystalline polymorphs of the sodium salt of fosinopril, especially polymorph A, which is currently used as an antihypertensive agent belonging to the group of inhibitors of the angiotensin converting enzyme.

### PRIOR ART

Fosinopril is a derivative of phosphinic acid, of chemical name [1[S*(R*)], 2α,2β]-4-cyclohexyl-1-[[[2-methyl-1-(loxoproxy)propoxy] (4-phenylbutyl)phosphinyl] acetyl]-L-proline, whose sodium salt is shown in the formula below:

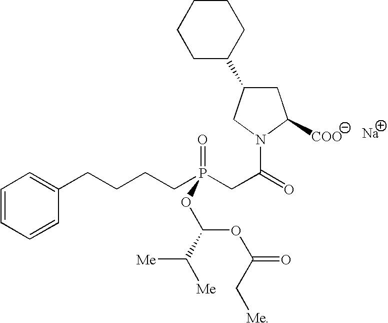

Specifically, the sodium salt of fosinopril was first described in Fed. Proc., Fed. Am. Soc. Exp. Biol., 1984, 43, 733, and its preparation is described in patent U.S. Pat. No. 4,873,356.

The sodium salt of fosinopril exists in two different crystalline forms, called polymorphs A and B, polymorph A being the one currently used for the preparation of medicinal products.

European patent EP-B-0442378 describes specific procedures to selectively obtain each of the two polymorphs of the sodium salt of fosinopril; as sated therein, polymorph A is the more stable one from the thermodynamic point of view.

As described in he above mentioned patent, when the fosinopril salt or a mixture of fosinopril and an alkaline metal donor are placed in a ketonic or hydroxylic solvent, or in a mixture of both, the quantity of water is decisive in the formation of one polymorph or the other. Form A predominates when the quantity of water is higher than 0.2% (v/v) of the total water/solvent system, preferably between 1 and 3%. With water concentrations between 0.2% and 0.0%, polymorph B formation predominates.

European patent EP-B-044237 specifically describes a procedure for the preparation of polymorph A, where a mixture of fosinopril and sodium ethylhexanoate is treated in acetone containing 1.7% of water (v, v), stirred at room temperature and where polymorph A is then isolated by filtration. Also described is that the suspension of polymorph B of sodium fosinopril in acetone containing 2% of water, and further stirring of the mixture at room temperature, lead to isolation by filtration of form A.

For polymorph B preparation, the above mentioned European patent describes a specific procedure consisting in evaporating to dryness a polymorph A solution in methanol at 35° C.

Regarding the obtention of polymorph A, which is the one presently marketed, the procedure described in the aforesaid European patent has the disadvantage of requiring the use of a certain quantity of water, which leads to a greater risk of producing untoward degradations of the active substance.

As shown experimentally, sodium fosinopril in mixtures of ketonic or alcoholic solvents and water undergoes hydrolysis, leading to the formation of the corresponding phosphinic acid, a product known as fosinoprilate. This hydrolytic degradation increases with time and with higher temperature and higher water content of the solvent.

Regarding the obtention of polymorph B, methanol solutions of sodium fosinopril evaporated in an atomizer at room temperature have been found to yield a form B which is spontaneously hydrated under air exposure, thereby increasing the risk of hydrolytic degradation.

Thus, there remains a need for new procedures for the preparation of the polymorphs of the sodium salt of fosinopril, particularly polymorph A, in order to obtain a lower risk of hydrolytic degradation of the active ingredient.

Object of the Invention

The object of the invention is a procedure or the selective preparation of the crystalline polymorphs of fosinopril, particularly polymorph A, leading to a lower risk of hydrolytic degradation of the active ingredient.

### BRIEF DESCRIPTION OF THE DRAWINGS

FIG. 1 shows the IR spectrum of polymorph A of the sodium salt of fosinopril, recorded in KBr tablet.

FIG. 2 shows the nuclear magnetic resonance spectrum of carbon 13 (¹³C-NMR), in solid state, of polymorph A of the sodium salt of fosinopril.

FIG. 3 snows the IR spectrum of polymorph B of the sodium salt of fosinopril, recorded in KBr tablet.

FIG. 4 shows the nuclear magnetic resonance spectrum of carbon 13 (¹³C-NMR), in solid state, of polymorph B of the sodium salt of fosinopril.

### DESCRIPTION OF THE INVENTION

The authors of the present invention have found that the obtention of polymorph A does not necessarily require the crystallization of the sodium salt of fosinopril in a medium containing substantial quantities of water, thereby avoiding the problems related to hydrolytic degradations of the active substance.

The procedure object of the invention is characterized by the formation of a total or partial solution of sodium fosinopril in a solvent or mixture of solvents containing less than 0.2% (v/v) of water with respect to the total amount of water plus solvent, in a way that:
(a) the solvent is selected from those containing oxygen in their molecule and the nitriles or mixtures thereof, provided that the solvent or mixture of solvents contains more than 0.4% (v/v) of a C₁-C₄ aliphatic alcohol, linear or ramified, in which case polymorph A crystallizes at a temperature ranging between 0° C. and 50° C. and separates from the mixture, or
(b) the solvent is tetrahydrofuran, with no other solvent mixture, in this case, when polymorph A is seeked, the starting point is a partial solution of the sodium salt of fosinopril crystallized at a temperature between 0° C. and 50° C., or the starting point is a total solution of this salt crystallized at a temperature between 20° C. and 35° C., and when polymorph B is seeked, the starting point is a total solution of the sodium salt of fosinopril crystallized at a temperature between 0° C. and 5° C., and the polymorph obtained in each case is separated from the mixture.

For the purposes of this invention, and unless expressly stated otherwise, a solution of the fosinopril salt in the solvent or solvent mixture is to be understood as any degree of solution, with total solution of the product not being necessary at the beginning of the process.

In the case of option (a) above, the following solvents may be listed among those containing oxygen in their molecule: the C₁-C₆ aliphatic alcohols, linear or ramified, such as methanol, ethanol, n-propanol, isopropanol, n-butanol, etc.; aliphatic cyclic alcohols, such as cyclohexanol; dioles, such as ethylene glycol, 1,2-propylene glycol, 1,3-propanodiole, 1,4-butanodiole, etc.; C₁-C₆ aliphatic ketones, linear or ramified, such as acetone, methylethylketone, methylisobutylketone, etc.; cyclic aliphatic ketones, such as cyclohexanone; low chain aliphatic esters, such as ethyl acetate; low chain aliphatic ethers, such as ethyl ether, isopropylic ether, etc.; cyclic aliphatic ethers, such as tetrahydrofuran and dioxane.

Among the solvents which contain oxygen in their molecule, acetone, methylethylketone and tetrahydrofuran are preferably used; among the nitrile-type solvents, acetonitrile is preferred.

A mandatory condition for option (a) is that the solvent system contains more than 0.4% (v/v) of a C₁-C₄ aliphatic alcohol, linear or ramified, of which methanol and isopropanol are usually preferred. The proportion of alcohol in the solvent system is preferably between 1% and 5% (v/v).

The previously obtained sodium salt of fosinopril itself may be used as starting point, whether in the form of polymorph A, polymorph B or a mixture of both polymorphs, in which case this salt is mixed with the solvent system and then stirred at the prescribed temperature for the time required for the formation of the desired polymorph.

The sodium salt of fosinopril can also be formed in the selected solvent system itself by adding non-salified fosinopril and the sodium salt of an aliphatic carboxylic acid, linear or ramified and of chain equal to or higher than C₅, preferably sodium 2-ethylhexanoate and the sodium salt of pivalic acid.

In the case of option (a), a crystallization temperature between 35° C. and 45° C. is preferred; however, at the time of substance isolation, e.g. by means of filtration, it is advisable to cool off the mixture at a temperature between 15° C. and 25° C.

A preferred embodiment of the invention comprises mixing a solution of an aliphatic carboxylic acid, linear or ramified and of chain equal to or higher than C₅, in a solvent selected from those containing oxygen in their molecule and the nitriles or mixtures thereof, with a sodium methoxide solution in methanol and with a fosinopril solution in the selected solvent, so that the resulting mixture has a water content lower than 0.2% and a methanol content higher than 0.4% with respect to the total volume of the mixture, and proceeding with crystallization at a temperature between 0° C. and 50° C. with further separation from the mixture of the precipitated crystals of sodium fosinopril polymorph A.

In the above embodiment the following aspects are preferred, independently or altogether: aliphatic carboxylic acid is selected from 2-ethylhexanoic acid and pivalic acid; the aliphatic carboxylic acid and sodium methoxide ratios are close to stoichiometric; the sodium salt ratio of the aliphatic carboxylic acid as related to fosinopril is between 1.0 and 1.2 versus the stoichiometric ratio; methanol content is between 1% and 5% (v/v) of total water plus solvent; the solution of the sodium salt of the aliphatic carboxylic acid is added to the fosinopril solution; the crystallization temperature is between 35° C. and 45° C.; and the mixture is cooled off at a temperature between 15° C. and 25° C. before polymorph A crystals of the sodium salt of fosinopril are separated from the mixture.

Another preferred embodiment of the invention comprises mixing the sodium salt of an aliphatic carboxylic acid, linear or ramified and of chain equal to or higher than C₅, and a solution of fosinopril in a solvent selected from those containing oxygen in their molecule and the nitrites or mixtures thereof, so that the resulting mixture has a water content lower than 0.2% and a linear or ramified C₁-C₄ aliphatic alcohol content higher than 0.4% with respect to the total volume of the mixture, and crystallizing at a temperature between 0° C. and 50° C., with further separation from the mixture of the precipitated crystals of sodium fosinopril polymorph A.

In the above embodiment the following aspects are preferred, independently or altogether: the aliphatic carboxilic acid is selected from 2-ethylhexanoic acid and pivalic acid; the sodium salt ratio of aliphatic carboxilic acid as related to fosinopril is between 1.0 and 1.2 versus the stoichiometric ratio; the linear or ramified C₁-C₄ aliphatic alcohol is methanol or isopropanol and its content is between 1% and 5% (v/v) of total water plus solvent; the crystallization temperature is between 20° C. and 25° C.; and the mixture is cooled off at a temperature between 15° C. and 25° C. before polymorph A crystals of the sodium salt of fosinopril are separated from the mixture.

Another preferred embodiment of the invention comprises mixing the sodium salt of fosinopril, in either of its crystalline forms or a mixture thereof, with a solvent selected from those containing oxygen in their molecule and the nitrites or mixtures thereof, so that the resulting mixture has a water content lower than 0.2% and a content of linear or ramified C₁-C₄ aliphatic alcohol higher than 0.4% with respect to the total volume of the mixture, and proceeding with crystallization at a temperature between 0° C. and 50° C., with further separation from the mixture of the precipitated crystals of sodium fosinopril polymorph A.

In the above embodiment the following aspects are preferred, independently or altogether: the linear or ramified C₁-C₄ aliphatic alcohol is methanol or isopropanol and its content is between 1% and 5% (v/v) of total water plus solvent; the crystallization temperature is between 35° C. and 45° C.; and the mixture is cooled off at a temperature between 15° C. and 25° C. before polymorph A crystals of the sodium salt of fosinopril are separated from the mixture.

Another preferred embodiment of the invention comprises mixing fosinopril and the sodium salt of an aliphatic carboxylic acid, linear so ramified and of chain equal to or higher than C₅, in tetrahydrofuran so that the resulting mixture has a water content lower than 0.2% with respect to the total volume of the mixture, and proceeding with crystallization at a temperature between 20° C. and 35° C., with further separation from the mixture of the precipitated crystals of sodium fosinopril polymorph A.

Another preferred embodiment of the invention comprises mixing fosinopril and the sodium salt of an aliphatic carboxylic acid, linear or ramified and of chain equal to or higher than C₅, in tetrahydrofuran until total solution is formed, so that the resulting solution has a water content lower than 0.2% with respect to the total volume of the mixture, and proceeding with crystallization at a temperature between 0° C. and 5° C., with further separation from the mixture of the precipitated crystals of sodium fosinopril polymorph B.

In the two previous embodiments, the aliphatic carboxylic acid is selected preferably from 2-ethylhexanoic acid and pivalic acid.

Finally, another preferred embodiment of the invention comprises mixing the sodium salt of fosinopril, in either of its crystalline forms or a mixture thereof, in tetrahydrofuran so that the resulting mixture has a water content lower than 0.2% with respect to the total volume of the mixture, and proceeding with crystallization at a temperature between 20° C. and 35° C., with further separation from the mixture of the precipitated crystals of sodium fosinopril polymorph A.

The examples that follow are outlined to provide the expert with a sufficiently clear and complete explanation of this invention, but should not be considered as limitations on the essential aspects of the object of the invention, as exposed in the previous sections of this description.

### EXAMPLES

### Example 1 Obtention of Polymorph A of the Sodium Salt of Fosinopril

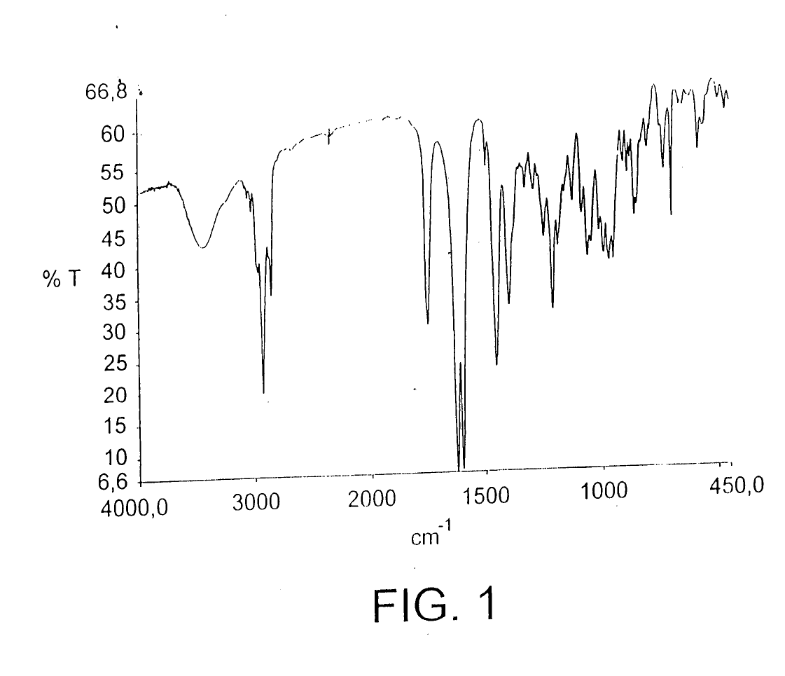

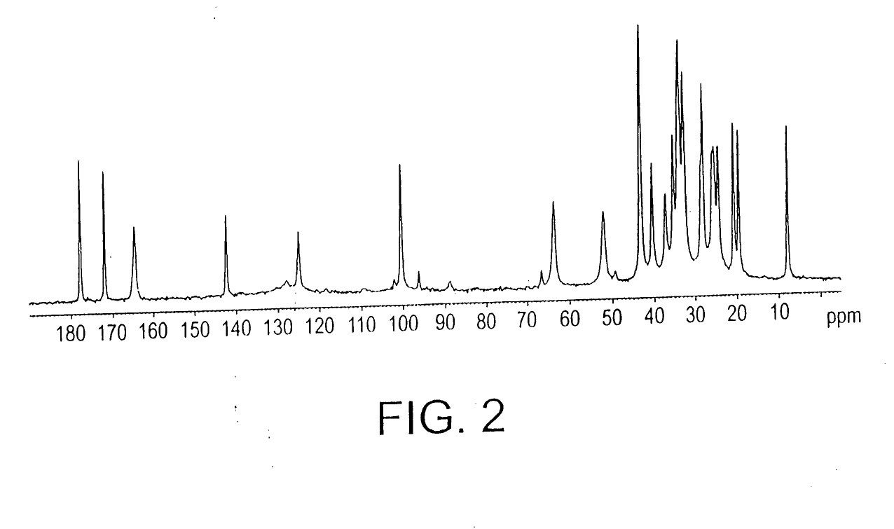

7.0 kg of 2-ethylhexanoic acid are added to 25 kg of anhydrous acetone (water content lower than 0.2% v/v, cooled off between 0° C. and 5° C., and 9.0 kg of a sodium methoxide solution in 30% methanol are added gradually. The resulting solution is added to a mixture of 22 kg of fosinopril and 160 kg of anhydrous acetone heated between 35° C. and 45° C. The mixture is then cooled off at room temperature and the sodium fosinopril crystals are separated by filtration and vacuum-dried to yield 20.7 kg of polymorph A (90% of theoretical yield). The IR spectrum and the ¹³C-NMR spectrum are shown in FIGS. 1 and 2, respectively. None of the spectrums show significant amounts of polymorph B.

### Example 2 Obtention of Polymorph B of the Sodium Salt of Fosinopril

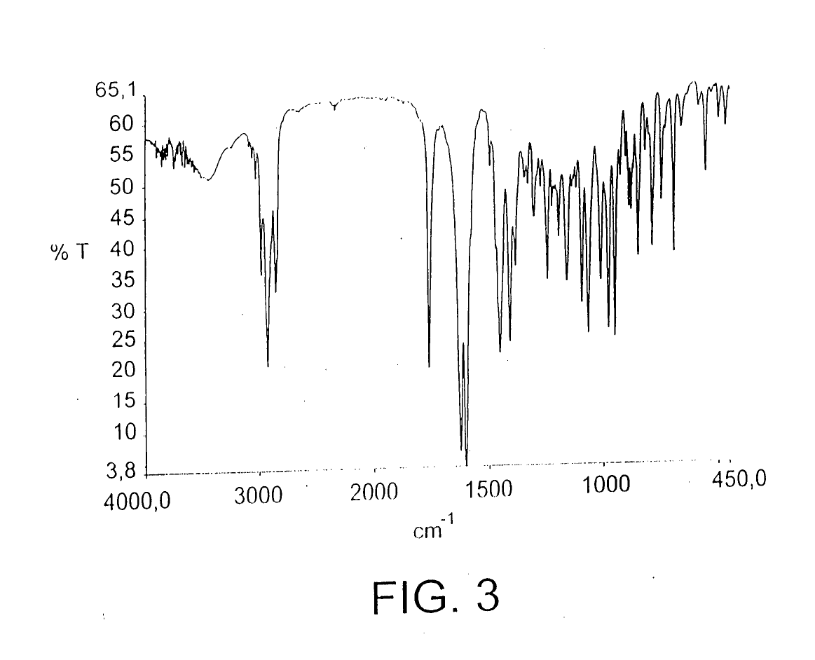

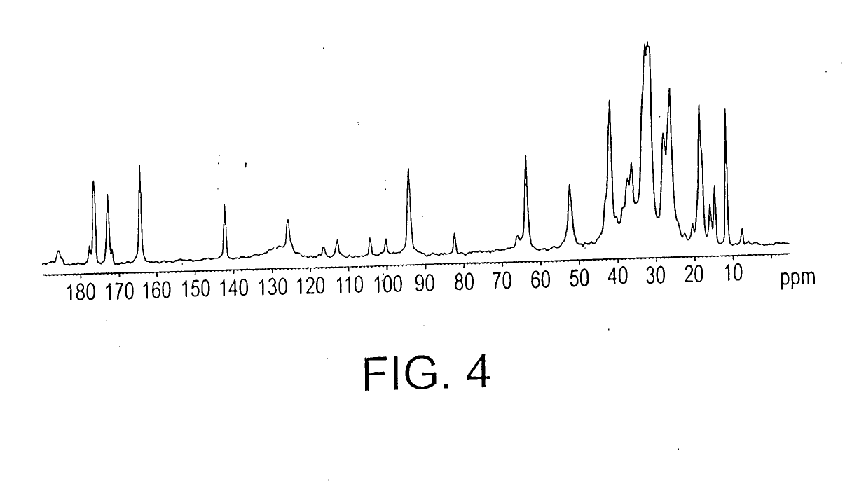

2.0 g of sodium 2-ethylhexanoate are added to a solution of 5.5 g fosinopril in 60 mL of tetrahydrofuran (water content according to Karl-Fisher lower than 0.2%) cooled off between 0° C. and 5° C. After one-hour stirring at the indicated temperature, the suspension is filtered, the filtered precipitate is washed with tetrahydrofuran, cooled off between 0° C. and 5° C., and vacuum-dried to yield 5.04 g of polymorph B of the sodium salt of fosinopril. The IR spectrum and the ¹³C-NMR spectrum are shown in FIGS. 3 and 4, respectively. None of the spectrums show significant amounts of polymorph A.

### Example 3 Obtention of Polymorph A of the Sodium Salt of Fosinopril

3.5 g of sodium 2-ethylhexanoate are added to a solution of 12.0 g of fosinopril in 330 mL of tetrahydrofuran (water content according to Karl-Fisher lower than 0.2%), kept between 20° C. and 30° C. After 30-minute stirring at the indicated temperature, the suspension is filtered, the filtered precipitate is washed with tetrahydrofuran kept between 20° C. and 30° C., and vacuum-dried to yield 9.8 g of polymorph A of the sodium salt of fosinopril.

### Example 4 Obtention of Polymorph A of the Sodium Salt of Fosinopril

3.5 g of sodium 3-ethylhexanoate are added at 25° C. to a solution of fosinopril (10.0 g) in tetrahydrofuran (130 mL) (water content according to Karl-Fisher lower than 0.2%) containing 1.0% of methanol (v/v). The mixture is kept at that temperature and stirred for one hour, the crystals of sodium fosinopril are filtered and vacuum-dried to yield 9.6 g of polymorph A.

### Example 5 Obtention of Polymorph A of the Sodium Salt of Fosinopril

Proceeding as in example 4, but replacing tetrahydrofuran with methylethylketone (130 mL;, 11.4 g of polymorph A of the sodium salt of fosinopril are obtained.

### Example 6 Obtention of Polymorph A of the Sodium Salt of Fosinopril

Proceeding as in example 4, but replacing tetrahydrofuran with acetonitrile (130 mL), 9.7 g of polymorph A of the sodium salt of fosinopril are obtained.

### Example 7 Obtention of polymorph A of the Sodium Salt of Fosinopril

Proceeding as in example 4, but replacing tetrahydrofuran with acetone (130 mL) and methanol by isopropanol (1.3 mL), 11.3 g of polymorph A of the sodium salt of fosinopril are obtained.

### Example 8 Obtention of Polymorph A of the Sodium Salt of Fosinopril

A suspension of 2.8 g of polymorph B of fosinopril is stirred for one hour at room temperature in 29 mL of acetone (water content according to Karl-Fisher lower than 0.2% containing 0.8 mL of methanol (2.7% v/v). The precipitate is filtered, washed with acetone and vacuum-dried to yield 2.3 g of polymorph A of sodium fosinopril.

1. A procedure for the selective preparation of the crystalline polymorphs of the sodium salt of fosinopril, characterized by the formation of a total or partial solution of sodium fosinopril in a solvent or mixture of solvents containing less than 0.2% (v/v) of water with respect to total water plus solvent, wherein:
(a) the solvent is selected from those containing oxygen in their molecule and the nitriles or mixtures thereof, provided that the solvent or mixture of solvents contains more than 0.4% (v/v) of a C₁-C₄ aliphatic alcohol, linear or ramified, in which case polymorph A crystallizes at a temperature ranging between 0° C. and 50° C. and separates from the mixture, or
(b) the solvent is tetrahydrofuran, with no other solvent mixture, in this case, when polymorph A is seeked, the starting point is a partial solution of the sodium salt of fosinopril crystallized at a temperature between 0° C. and 50° C., or the starting point is a total solution of this salt crystallized at a temperature between 20° C. and 35° C., and when polymorph B is seeked, the starting point is a total solution of the sodium salt of fosinopril crystallized at a temperature between 0° C. and 5° C., and the polymorph obtained in each case is separated from the mixture.

2. The procedure according to claim 1, wherein the solvent containing oxygen in its molecule is selected from: methanol, ethanol n-propanol, isopropanol, n-butanol, cyclohexanol, ethylene glycol, 1,2-propylene glycol, 1,3-propanodiole, 1,4-butanodiole; acetone, methylethylketone, methylisobutylketone; cyclohexanone; ethyl acetate; ethyl ether, isopropylic ether, tetrahydrofuran and dioxane.

3. The procedure according to claim 1 wherein the solvent is selected from acetone, methylethylketone, tetrahydrofuran and acetonitrile, or mixtures thereof.

4. The procedure according to claim 1, wherein the C₁-C₄ aliphatic alcohol, linear or ramified, is selected from methanol and isopropanol, and the proportion of said alcohol in the solvent system is between 1% and 5% (v/v).

5. The procedure according to claim 2, wherein the total or partial solution of sodium fosinopril is prepared by adding non-salified fosinopril to the solvent system and by the addition or in situ formation of sodium salt of an aliphatic carboxylic acid, linear or ramified and of chain equal to or higher than C₅.

6. The procedure according to claim 5, wherein the aliphatic carboxylic acid is selected from 2-ethylhexanoic acid and pivalic acid.

7. The procedure according to claim 5, wherein it comprises mixing a solution of the aliphatic carboxylic acid in a solvent selected from those containing oxygen in their molecule and the nitriles or mixtures thereof, with a sodium methoxide solution in methanol and with a fosinopril solution in the selected solvent, so that the resulting mixture has a water content lower than 0.2% and a methanol content higher than 0.4% with respect to the total volume of the mixture, and proceeding with crystallization at a temperature between 0° C. and 50° C., with further separation from the mixture of the precipitated crystals of sodium fosinopril polymorph A.

8. The procedure according to claim 7, wherein, independently or altogether, the following characteristics are comprised: the aliphatic carboxylic acid and sodium methoxide ratios match stoichiometric ratios, the sodium salt ratio of the aliphatic carboxylic acid as related to the fosinopril is between 1.0 and 1.2 versus the stoichiometric ratio; the methanol content is between 1% and 5% (v/v) of total water plus solvent; the solution of the sodium salt of the aliphatic carboxylic acid is added to the fosinopril solution; the crystallization temperature is between 35° C. and 45° C.; and the mixture is cooled off at a temperature between 15° C. and 25° C. before polymorph A crystals of the sodium salt of fosinopril are separated from the mixture.

9. The procedure according to claim 5, wherein it comprises mixing the sodium salt of the aliphatic carboxylic acid and a solution of fosinopril in a solvent selected from those which contain oxygen in their molecule and the nitriles or mixtures thereof, so that the resulting mixture has a water content lower than 0.2% and a linear or ramified C₁-C₄ aliphatic alcohol content higher than 0.4% with respect to the total volume of the mixture, and proceeding with crystallization at a temperature between 0° C. and 50° C., with further separation from the mixture of the precipitated crystals of sodium fosinopril polymorph A.

10. The procedure according to claim 9, wherein, independently or altogether, the following characteristics are comprised: the aliphatic carboxylic acid is selected from 2-ethylhexanoic acid and pivalic acid; the sodium salt ratio of aliphatic carboxylic acid as related to fosinopril is between 1.0 and 1.2 versus the stoichiometric ratio; the linear or ramified C₁-C₄aliphatic alcohol is methanol or isopropanol and its content is between 1% and 5% (v/v) of total water plus solvent; the crystallization temperature is between 35° C. and 45° C.; and the mixture is cooled off at a temperature between 15° C. and 25° C. before polymorph A crystals of the sodium salt of fosinopril are separated from the mixture.

11. The procedure according to claim 1, wherein the total or partial solution of sodium fosinopril is prepared by adding the sodium salt of fosinopril to the solvent system, in either of its crystalline forms A or B or a mixture of both.

12. The procedure according to claim 11, wherein it comprises mixing the sodium salt of fosinopril with a solvent selected from those containing oxygen in their molecule and the nitriles or mixtures thereof, so that the resulting mixture has a water content lower than 0.2% and a content of a linear or ramified C₁-C₄ aliphatic alcohol higher than 0.4% with respect to the total volume of the mixture, and proceeding with crystallization at a temperature between 0° C. and 50° C., with further separation from the mixture of the precipitated crystals of sodium fosinopril polymorph A.

13. The procedure according to claim 12, wherein independently or altogether, the following characteristics are comprised: the linear or ramified C₁-C₄ aliphatic alcohol is methanol or isopropanol and its content is between 1% and 5% (v/v) of total water plus solvent; the crystallization temperature is between 35° C. and 45° C.; and the mixture is cooled off at a temperature between 15° C. and 25° C. before polymorph A crystals of the sodium salt of fosinopril are separated from the mixture.

14. The procedure according to claim 5, wherein it comprises mixing fosinopril and the sodium salt of aliphatic carboxylic acid in tetrahydrofuran, so that the resulting mixture has a water content lower than 0.2% with respect to the total volume of the mixture, and proceeding with crystallization at a temperature between 20° C. and 35° C., with further separation from the mixture of the precipitated crystals of sodium fosinopril polymorph A.

15. The procedure according to claim 5, wherein it comprises mixing fosinopril and the sodium salt of aliphatic carboxylic acid in tetrahydrofuran until a total solution is formed, so that the resulting solution has a water content lower than 0.2% with respect to the total volume of the mixture, and proceeding with crystallization at a temperature between 0° C. and 5° C., with further separation from the mixture of the precipitated crystals of sodium fosinopril polymorph B.

16. The procedure according to claim 14, wherein the aliphatic carboxylic acid is selected from 2-ethylhexanoic acid and pivalic acid.

17. The procedure according to claim 11, wherein it comprises mixing the sodium salt of fosinopril in tetrahydrofuran, so that the resulting mixture has a water content lower than 0.2% with respect to the total volume of the mixture, and proceeding with crystallization at a temperature between 20° C. and 35° C., with further separation from the mixture of the precipitated crystals of sodium fosinopril polymorph A.
